(19) United States
(12) Patent Application Publication
(10) Pub. No.: US 2024/0383050 A1
(43) Pub. Date: Nov. 21, 2024

(54) DRILL

(71) Applicant: TOYOTA JIDOSHA KABUSHIKI KAISHA, Toyota-shi (JP)

(72) Inventors: Takuya UEDA, Toyota-shi (JP); Chohei KOSERA, Nagoya-shi (JP); Hiroto FUKUDA, Toyota-shi (JP)

(73) Assignee: TOYOTA JIDOSHA KABUSHIKI KAISHA, Toyota-shi (JP)

(21) Appl. No.: 18/635,183

(22) Filed: Apr. 15, 2024

(30) Foreign Application Priority Data
May 15, 2023 (JP) 2023-080106

(51) Int. Cl. B23B 51/06

(52) U.S. Cl. CPC B23B 51/068; B23B 2251/12

(57) ABSTRACT

The drill includes a main blade having a wicking amount, a thinning blade, a thinning back portion, and an oil hole. The thinning bottom is along the first radius. The thinning back portion is along the second radius. The pair of thinning bottoms includes a thinning separation amount. (1) The first radius for the wicking amount ranges from 0.5×f to 1.2×f, and f represents the wicking amount. (2) The second radius ranges from 5.5 mm to 7.5 mm. (3) The thinning separation amount ranges from 0.5 mm to 1.2 mm. (4) The thinning-oil hole distance ranges from 0.1 mm to 0.8 mm (5) The thinning range from the first thinning end to the second thinning end is in the range from (D/2−1.5 mm) to (D/2−0.2 mm) with respect to the diameter, and D represents the diameter.

### CROSS-REFERENCE TO RELATED APPLICATION

This application claims priority to Japanese Patent Application No. 2023-080106 filed on May 15, 2023, incorporated herein by reference in its entirety.

### BACKGROUND

### 1. Technical Field

The technology disclosed herein relates to a drill.

### 2. Description of Related Art

Japanese Unexamined Patent Application Publication No. 2021-11013 (JP 2021-11013 A) discloses a drill including a thinning portion.

### SUMMARY

Swarf generated by a thinning blade is curled at the thinning portion and discharged while being split. If the swarf is not properly split and discharged, however, the thrust resistance increases and abnormal wear or chipping of the drill occurs.

A drill of the present disclosure includes:
a drill body including an outer peripheral surface along a circumscribed circle having a diameter about an axis center;
a pair of main blades provided at a tip of the drill body and extending from the outer peripheral surface toward the axis center,
the main blades being positioned over a center core by a center core advancing amount with respect to a diameter through the axis center;
a pair of thinning blades each provided from a first thinning end to a thinning bottom,
the first thinning end being positioned at an end of the main blade near the axis center,
the thinning bottom being positioned closer to the axis center than the first thinning end and provided at a position where the center core advancing amount f is smaller than the center core advancing amount of the main blade;
a pair of thinning back portions each extending from the thinning bottom to a second thinning end; and
a pair of oil holes provided at the tip of the drill body.

The main blades, the thinning blades, the thinning back portions, and the oil holes are disposed rotationally symmetrical about the axis center.

A pair of the thinning bottoms is each provided along a first inscribed circle having a first radius.

The thinning back portions are each provided along a second inscribed circle having a second radius larger than the first radius.

A distance between a pair of parallel imaginary lines passing through the thinning bottoms is a thinning separation amount.

A shortest distance between the oil hole and the thinning back portion is a thinning-oil hole distance.

A range from the first thinning end to the second thinning end is a thinning range.
(1) The first radius ranges from 0.5×f to 1.2×f with respect to the center core advancing amount, and f represents the center core advancing amount.
(2) The second radius ranges from 5.5 mm to 7.5 mm.
(3) The thinning separation amount ranges from 0.5 mm to 1.2 mm.
(4) The thinning-oil hole distance ranges from 0.1 mm to 0.8 mm.
(5) The thinning range is a range from (D/2−1.5 mm) to (D/2−0.2 mm) with respect to the diameter, and D represents the diameter.
   With the configuration of the present disclosure, the swarf can smoothly be split and discharged by providing the numerical ranges of (1) to (4). Therefore, the thrust resistance can be reduced. Further, the rigidity of a chisel center portion can be secured by providing the numerical range of (5). Thus, abnormal wear, chipping, breakage, etc. of the drill can be suppressed. Accordingly, the life of the drill can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a distal end view of a drill 1;

FIG. 2 is an enlarged view of the vicinity of the axis center AX of FIG. 1;

FIG. 3A is a top view of a conventional drill 101; and

FIG. 3B is a front view of the drill 1 of this embodiment.

### DETAILED DESCRIPTION OF EMBODIMENTS

### Structure of the Drill 1

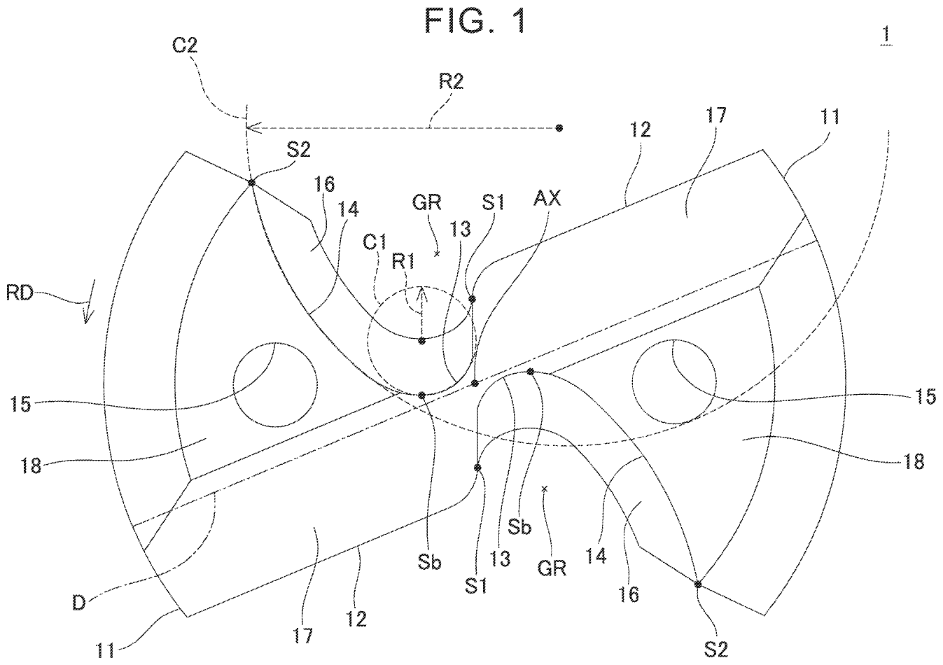

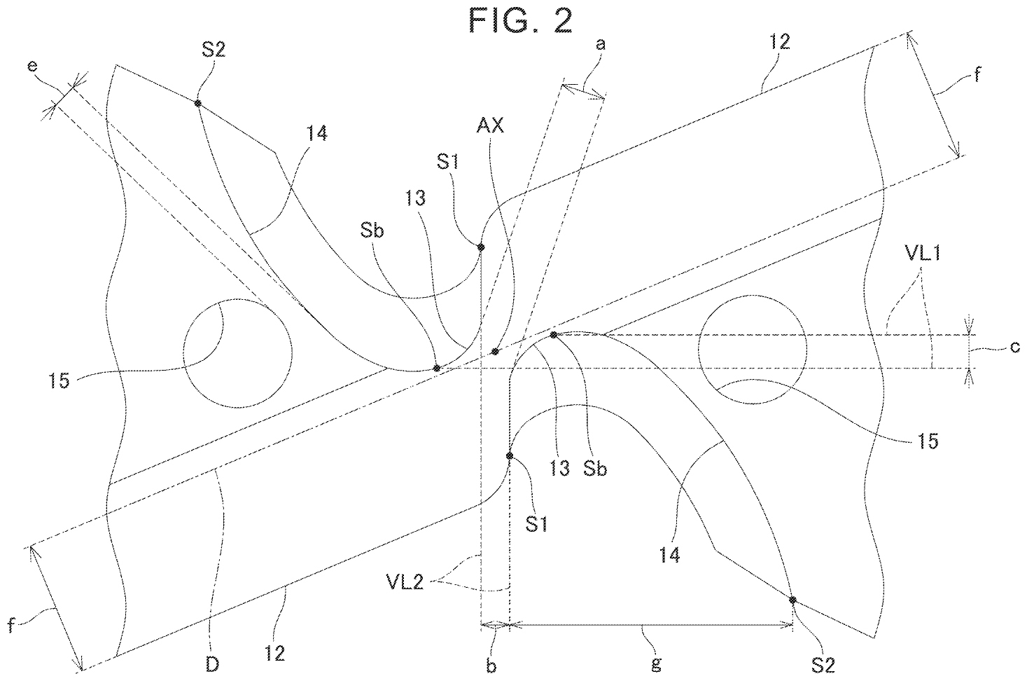

FIG. 1 shows a front end view of a drill 1. FIG. 1 is a view of a distal end of a drill 1 viewed from an axis center AX. FIG. 2 shows an enlarged view of the vicinity of the axis center AX of FIG. 1. The drill 1 is mainly used for drilling a steel material. An example of the steel material is a crankshaft material.

The body of the drill 1 is provided with an outer peripheral surface 11. The outer peripheral surface 11 is a surface along a circumscribed circle having a diameter D centered on the axis center AX. A spiral groove portion GR is formed on the outer peripheral surface 11. The drill 1 mainly includes a pair of main blades 12, a pair of thinning blades 13, a pair of thinning back portions 14, a pair of oil holes 15, a pair of thinning surfaces 16, a pair of first relief surfaces 17, and a pair of second relief surfaces 18. Each of these pair of components is arranged rotationally symmetrically with respect to the axis center AX. Accordingly, only one of a pair of components may be described herein.

The main blade 12 is formed at a distal end portion of the body of the drill 1. The main blade 12 extends from the outer peripheral surface 11 toward the axis center AX. As shown in FIG. 2, the main blade 12 has a centering amount f with respect to the diameter D passing through the axis center AX and is located at the centering position.

The thinning blade 13 is a blade formed from the first thinning end S1 to the thinning bottom Sb. The first thinning end S1 is located at an end portion of the main blade 12 on the axis center AX side. The thinning bottom Sb is located closer to the axis center AX than the first thinning end S1, and is located at a position where the wicking height f is smaller than that of the main blade 12. The thinning bottom Sb is formed along a first inscribed circle C1 having a first radius R1.

The thinning back portion 14 extends from the thinning bottom Sb to the second thinning end S2. The thinning back portion 14 is formed along a second inscribed circle C2 having a second radius R2. The second radius R2 is greater than the first radius R1.

The thinning surface 16 is a surface connected to the thinning blade 13 and the thinning back portion 14. The thinning surface 16 is a surface for discharging the chips generated by the cutting of the thinning blade 13 to the groove portion GR. The thinning surface 16 can enhance the dischargeability of the chips.

The first relief surface 17 is a surface connected to the rear of the main blade 12 in the rotational RD. The second relief surface 18 is a surface connected to the first relief surface 17. The first relief surface 17 and the second relief surface 18 are surfaces that have been lowered (relieved) in order to reduce friction during cutting. The oil hole 15 is formed in the second relief surface 18. The cutting oil agent can be discharged from the oil hole 15 through an oil tube (not shown).

With reference to FIG. 2, the thinning separation amount c, the thinning-oil hole distance e, the thinning range g, the chisel remaining width a, and the thinning misalignment amount b will be described. A pair of parallel virtual line VL1 are defined through each of the pair of thinning bottom Sb. The thinning separation amount c is a distance between the pair of virtual lines VL1. The thinning-oil hole distance e is the shortest distance between the oil hole 15 and the thinning back portion 14. The thinning range g is a range in which the first thinning end S1 to the second thinning end S2 are present.

The chisel remaining width a is the shortest distance between the pair of thinning blades 13. The thinning center deviation amount b is a deviation amount from the axis center AX of the thinning blade 13. Specifically, a pair of virtual line VL2 parallel to each other passing through each of the pair of first thinning end S1 is defined. The thinning core deviation amount b is a distance between the pair of virtual lines VL2.

The drill 1 in the technology of the present specification has five numerical ranges from (1) to (5) shown below. (1) The first radius R1 with respect to the wicking amount f is from “0.5×f to 1.2×f”. (2) The second radius R2 is from 5.5 mm to 7.5 mm. (3) The thinning separation amount c can be determined from 0.5 mm to 1.2 mm. (4) The thinning-oil hole distance e is from 0.1 mm to 0.8 mm. (5) The thinning range g is a range from “(D/2−1.5 mm) to (D/2−0.2 mm)” with respect to the diameter D.

In addition, in the drill 1 in the technique of the present specification, the chisel remaining width a ranges from 0.15 mm to 0.35 mm. In addition, the thinning misalignment amount b ranges from 0.02 mm to 0.12 mm.

### Effects

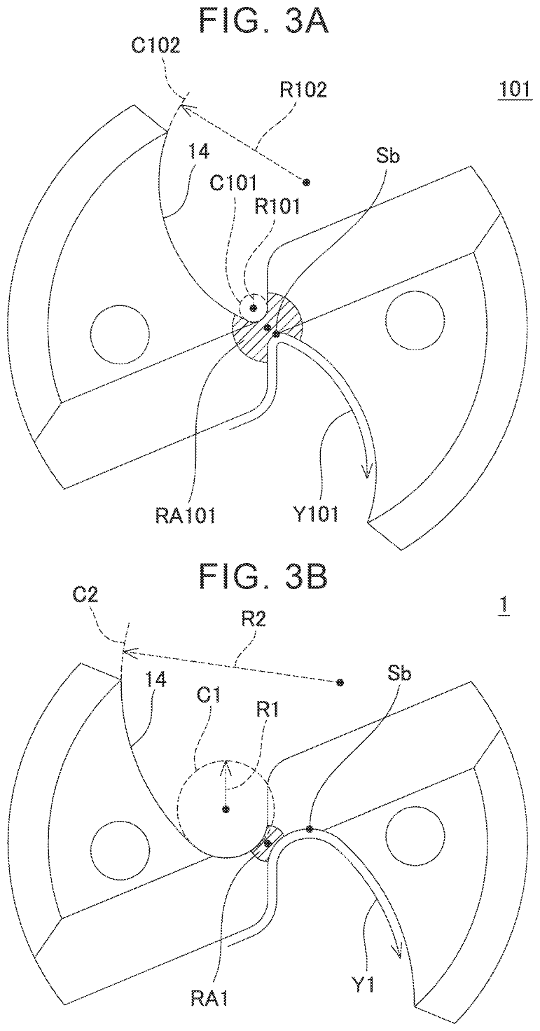

Using FIGS. 3A and 3B, the effects of the numerical value ranges of (1) to (5) will be described. FIG. 3A is a top view of a conventional drill 101. FIG. 3B is a front view of a drill 1 according to this embodiment, and is the same as FIG. 1. The conventional drill 101 of FIG. 3A is a drill that does not satisfy at least a part of the numerical value ranges of (1) to (5) described above. Specifically, the first radius R101 of the first inscribed circle C101 included in the conventional drill 101 is smaller than the lower limit of the numerical 10 value range of (1). The second radius R102 of the second inscribed circle C102 included in the conventional drill 101 is smaller than the second radius R2 of the second inscribed circle C2 included in the drill 1 of the present embodiment. In each of FIGS. 3A and 3B, the discharge path of the chips is indicated by arrows Y101 and Y1. In addition, the area where the first relief surface 17 and the second relief surface 18 are rubbed (worn) is indicated by hatching as the rubbing area RA101 and RA1. The rubbing area RA101 and RA1 can be determined experimentally.

The effects of the numerical ranges from (1) to (3) are explained. As indicated by the arrows Y101 and Y1, the chips generated by the thinning blade 13 are curled conically along the curvature of the first radius R101 and R1 in the thinning bottom Sb and are discharged while being divided. However, when the first radius R101 of the thinning bottom Sb is small, as shown in the conventional drill 101 of FIG. 3A, it is difficult to curl the chips. In addition, a space in which chips are discharged is reduced. When the second radius R102 of the thinning back portion 14 is small, the chip is not discharged smoothly, and the chip dischargeability is lowered. Therefore, the thrust resistance increases. In addition, the rubbing area RA101 increases.

Therefore, in the drill 1 of the present embodiment shown in FIG. 3B, by using the numerical value range of (1) in the first radius R1, it is possible to appropriately increase the first radius R1. Therefore, it is possible to easily curl the chips and to secure a discharge space. Further, by using the numerical value range of (2) in the second radius R2, the chip can be discharged smoothly. Further, by using the numerical range of (3) for the thinning separation amount c, it is possible to reduce the rubbing range of the flank surface. Therefore, the rubbing area can be reduced from RA101 (FIG. 3A) to RA1 (FIG. 3B). Thus, the thrust resistance can be reduced.

The effect of the numerical range of (4) will be described. When the thinning back portion 14 is applied to the oil hole 15, a protrusion is formed at an edge portion of the oil hole 15 at a boundary portion between the oil hole and the thinning back portion 14. Then, during cutting by the drill 1, stress is concentrated on the protruding portion of the oil hole 15, and chipping may occur in some cases. Therefore, in the drill 1 of the present embodiment, by using the numerical range of (4) for the thinning-oil hole distance e, it is possible to prevent the thinning back portion 14 from hanging on the oil hole 15. Since stress concentration in the oil hole 15 can be suppressed, occurrence of chipping can be prevented.

The effect of the numerical range of (5) will be described. As can be seen from FIG. 2, as the thinning separation amount c increases, the chisel remaining width a decreases. As the chisel remaining width a decreases, chipping tends to occur due to a decrease in the rigidity of the chisel center portion, and the tool life decreases. Therefore, in the drill 1 of the present embodiment, by using the numerical range of (5) in the thinning range g, it is possible to appropriately set the chisel remaining width a. Since the rigidity of the chisel center portion can be secured, occurrence of chipping can be suppressed.

As described above, in the drill 1 of the present embodiment, abnormal wear, chipping, breakage, and the like of the drill can be suppressed.

What is claimed is:

1. A drill comprising:
a drill body including an outer peripheral surface along a circumscribed circle having a diameter about an axis center;
a pair of main blades provided at a tip of the drill body and extending from the outer peripheral surface toward the axis center,
the main blades being positioned over a center core by a center core advancing amount with respect to a diameter through the axis center;
a pair of thinning blades each provided from a first thinning end to a thinning bottom,
the first thinning end being positioned at an end of the main blade near the axis center,
the thinning bottom being positioned closer to the axis center than the first thinning end and provided at a position where the center core advancing amount is smaller than the center core advancing amount f of the main blade;
a pair of thinning back portions each extending from the thinning bottom to a second thinning end; and
a pair of oil holes provided at the tip of the drill body, wherein
the main blades, the thinning blades, the thinning back portions, and the oil holes are disposed rotationally symmetrical about the axis center,
a pair of the thinning bottoms is each provided along a first inscribed circle having a first radius,
the thinning back portions are each provided along a second inscribed circle having a second radius larger than the first radius,
a distance between a pair of parallel imaginary lines passing through the thinning bottoms is a thinning separation amount,
a shortest distance between the oil hole and the thinning back portion is a thinning-oil hole distance,
a range from the first thinning end to the second thinning end is a thinning range,
(1) the first radius ranges from 0.5×f to 1.2×f with respect to the center core advancing amount, and f represents the center core advancing amount,
(2) the second radius ranges from 5.5 mm to 7.5 mm,
(3) the thinning separation amount ranges from 0.5 mm to 1.2 mm,
(4) the thinning-oil hole distance ranges from 0.1 mm to 0.8 mm, and
(5) the thinning range is a range from (D/2−1.5 mm) to (D/2−0.2 mm) with respect to the diameter, and D represents the diameter.
